(19) United States
(12) Patent Application Publication
(10) Pub. No.: US 2026/0225546 A1
(43) Pub. Date: Aug. 6, 2026

(54) AUTOMATED POSITION ADJUSTMENT OF INTERIOR COMPONENTS

(71) Applicant: Ford Global Technologies, LLC, Dearborn, MI (US)

(72) Inventors: Keith Weston, Canton, MI (US); John Robert Van Wiemeersch, Novi, MI (US); Stuart C. Salter, White Lake, MI (US); Matthew Johnson, Toledo, OH (US); Thomas Joseph Hermann, Troy, MI (US)

(73) Assignee: Ford Global Technologies, LLC, Dearborn, MI (US)

(21) Appl. No.: 19/026,980

(22) Filed: Jan. 17, 2025

(51) Int. Cl. B60R 16/037; B60N 2/00; B60N 2/02; G06V 20/59; G06V 40/16

(52) U.S. Cl. CPC B60R 16/037; B60N 2/0025; B60N 2/0244; G06V 20/59; G06V 40/172; G06V 40/174

(57) ABSTRACT

A computer of a vehicle includes a processor and memory storing instructions by the processor to: identify a mass distribution of the occupant; identify position settings for interior components of the vehicle based on the mass distribution of the occupant; initiate automated position adjustment of the interior components toward the position settings; abort automated position adjustment in response to detection of occupant discomfort, the occupant discomfort being audible and/or visual.

### BACKGROUND

Vehicles include interior components such as seats, shoulder-belt anchors, steering assemblies, etc. The position of the interior components may be manually or automatically adjusted by an occupant of the vehicle. In examples in which a vehicle is used by more than one occupant, each occupant may change the positions of the interior components each time a new occupant enters the vehicle.

### BRIEF DESCRIPTION OF THE DRAWINGS

FIG. 1 is a cut-away view of a vehicle.

FIG. 2 is a block diagram of a system of the vehicle.

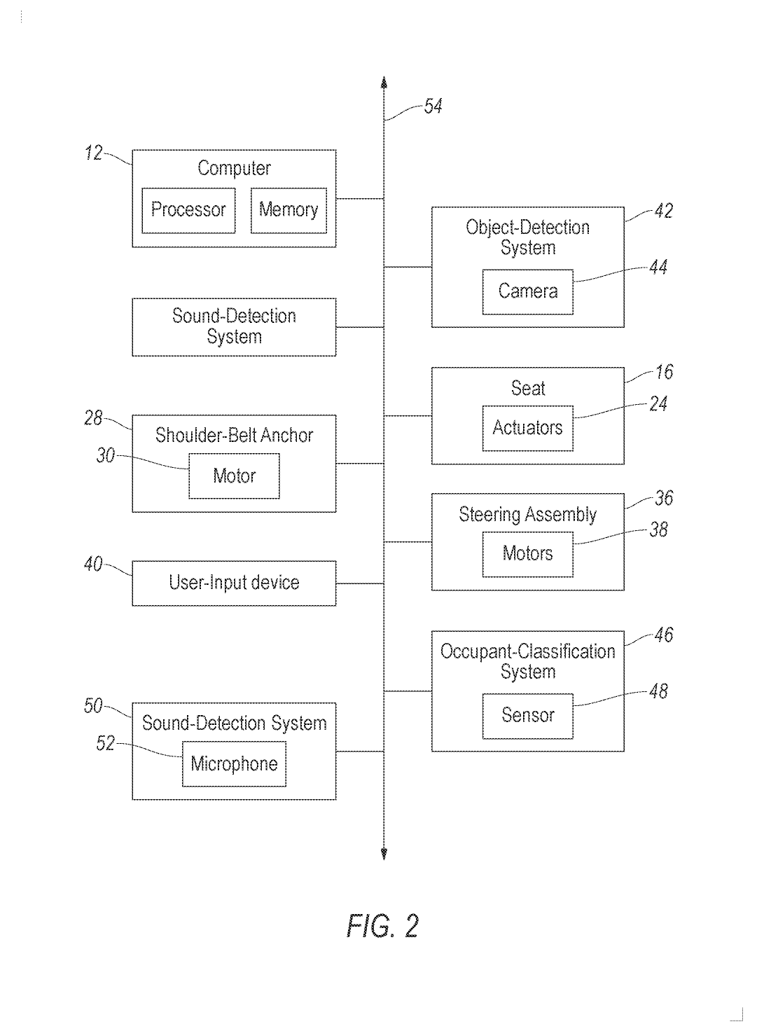

FIG. 3 is a flow chart for an example method.

### DETAILED DESCRIPTION

With reference to the Figures, wherein like numerals indicate like parts throughout the several views, a computer 12 of a vehicle 10 includes a processor and memory storing instructions by the processor to: identify a mass distribution of the occupant; identify position settings for interior components of the vehicle 10 based on the mass distribution of the occupant; initiate automated position adjustment of the interior components toward the position settings; abort automated position adjustment in response to detection of occupant discomfort, the occupant discomfort being audible and/or visual.

The computer 12 automatically adjusts interior components of the vehicle 10 based on the mass distribution of an occupant who is entering the vehicle 10 or who has recently entered the vehicle 10. The mass distribution of the occupant used to generate position settings for the interior components can be identified at the time of entry, e.g., using object detection at the exterior of the vehicle 10 or in the interior of the vehicle 10 and/or by using previously saved mass distribution data for the occupant. The position settings for the interior components are tailored to the mass distribution of the occupant and can be updated to include preferences of the occupant, e.g., to avoid adjustments that generated sensed occupant discomfort. The interior settings in some examples can be position of the seat 16, position of the steering wheel 34, seatbelt shoulder-anchor position, steering wheel, pedals, etc. During automatic adjustment of the interior components, in the event the automatic adjustment causes detected occupant discomfort, the computer 12 aborts the automated position adjustment. In some examples, when automated position adjustment is aborted, the computer 12 may maintain the position of the interior components at the position when the automated position adjustment was aborted, may reverse the settings a slight amount to relieve the discomfort, or may instruct the occupant to manually adjust the interior components, or may adjust the position settings and apply the adjusted position settings. The position settings tailored to the mass distribution of the occupant can be saved for later use for that occupant. The interior components may be, for example, seats 16, shoulder-belt anchors 28, steering assemblies 36, etc.

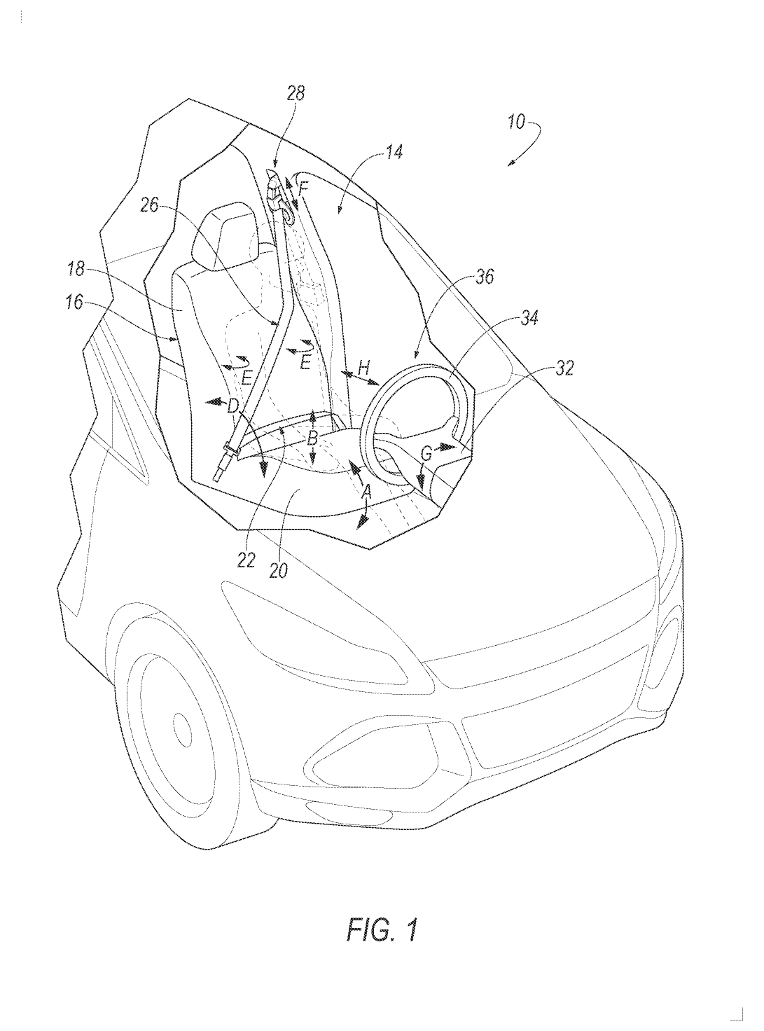

With reference to FIG. 1, the vehicle 10 may be any suitable type of ground vehicle, e.g., a passenger or commercial automobile such as a sedan, a coupe, a truck, a sport utility, a crossover, a van, a minivan, a taxi, a bus, etc. The vehicle 10 defines a vehicle-longitudinal axis L extending between a front end and a rear-end of the vehicle 10. The vehicle 10 defines a cross-vehicle axis C extending cross-vehicle from one side to the other side of the vehicle 10. The vehicle 10 defines a vertical axis V. The vehicle-longitudinal axis L, the cross-vehicle axis C, and the vertical axis V are perpendicular relative to each other. The vehicle 10 includes a vehicle frame (not numbered) and a vehicle body (not numbered). The vehicle frame and/or the vehicle body defines an occupant cabin 14 to house occupants of the vehicle 10. The occupant cabin 14 may extend across the vehicle 10, i.e., from one side to the other side of the vehicle 10. The vehicle body may include pillars.

The vehicle 10 includes one or more seats 16 in the occupant cabin 14. The seats 16 may be arranged in any suitable position in the occupant cabin 14, i.e., as front seats, rear seats, third-row seats, etc. The seat 16 includes a seatback 18 and a seat bottom 20. The seatback 18 may be supported by the seat bottom 20 and may be stationary or movable relative to the seat bottom 20. The seatback 18 and the seat bottom 20 may be adjustable in multiple degrees of freedom. Specifically, the seatback 18 and the seat bottom 20 may themselves be adjustable, in other words, adjustable components within the seatback 18 and/or the seat bottom 20, and/or may be adjustable relative to each other.

The seatback 18 may define an occupant-seating area 22. The occupant may be disposed in the occupant-seating area 22, as shown in the Figures. The occupant-seating area 22 is the space occupied by an occupant properly seated on the seat 16. The occupant-seating area 22 is seat 16-forward of the seatback 18 and above the seat bottom 20.

Each seat 16 can include actuators 24 for adjusting the seat 16 in multiple degrees of freedom, e.g., for/aft position of the seat 16, a tilt of the seat 16 (identified with “A” in FIG. 1), a height of the seat 16 (identified with “B” in FIG. 1), a recline angle of the seat 16 (identified with “D” in FIG. 1), a lumbar support position of the seat 16 (identified with “E” in FIG. 1), etc. The actuators 24 of the seat 16 are in communication with the computer 12 so that the computer 12 can control the operation of the actuators 24. The tilt of the seat 16 is an angle of a seat bottom 20 of the seat 16 relative to the occupant cabin 14 about a lateral axis, i.e., a pitch of the seat bottom 20. The height of the seat 16 is a vertical distance of a reference point on the seat bottom 20 relative to the occupant cabin 14. The recline angle of the seat 16 is an angle of a seatback 18 of the seat 16 relative to the seat bottom 20. The lumbar support position is a vehicle-forward position of a lumbar support bar, located in the seatback 18, relative to the seatback 18. Additionally, or alternatively, the seat 16 may be adjustable in other degrees of freedom.

The vehicle 10 includes one or more seatbelt assemblies 26. The seatbelt assemblies 26 each include a seatbelt retractor and the webbing extendable from the seatbelt retractor. The vehicle 10 may include any suitable number of seatbelt assemblies 26, i.e., one seatbelt assembly 26 for each occupant-seating area 22.

The seatbelt assembly 26, when fastened, is designed to control the kinematics of the occupant during certain vehicle 10 impacts or sudden stops. The seatbelt assembly 26 includes a lap-belt anchor coupled to the webbing, a shoulder-belt anchor 28, and a clip between the lap-belt anchor and the shoulder-belt anchor 28 to engage a buckle. The clip slides freely along the webbing and, when engaged with the buckle, divides the webbing into a lap belt and the shoulder belt. In such an example, the lap belt extends across the lap of the occupant, e.g., from the lap-belt anchor to the clip, and the shoulder belt extends in an upward direction from the clip to the shoulder-belt anchor 28. The seatbelt assembly 26 may be a three-point harness, meaning that the webbing is attached at three points around the occupant when fastened. The seatbelt assembly 26 may, in other examples, include another arrangement of attachment points. The webbing may be fabric, e.g., polyester. The hardware of the seatbelt assembly 26 (i.e., the seatbelt retractor, the webbing, the lap-belt anchor, and the shoulder-belt anchor 28) may be, in some examples, a conventional type.

In the example shown in the Figures, the webbing extends continuously from the seatbelt retractor to the lap-belt anchor. Specifically, the webbing extends from the seatbelt retractor along the pillar to the shoulder-belt anchor 28, from the shoulder-belt anchor 28 to the clip, and from the clip to the lab-belt anchor.

The seatbelt retractor provides payout and retraction of the webbing, e.g., via rotation of a spool of the seatbelt retractor. The seatbelt retractor may be mounted at any suitable location in the vehicle 10, e.g., the pillar in the example shown in the Figures. A housing of the seatbelt retractor is fixed to the body of the vehicle 10, i.e., is immovable relative to the body of the vehicle 10, and the webbing extends from and retracts into the housing. Specifically, one end of the webbing feeds into the seatbelt retractor, and the other end of the webbing is fixed to the lap-belt anchor in the example shown in the Figures.

In the example shown in the Figures, the lap-belt anchor is fixed to the vehicle body, e.g., the pillar, a floor panel, etc. In other words, the lap-belt anchor is immovable relative to the body of the vehicle 10.

The shoulder-belt anchor 28 is mounted to the body of the vehicle 10, as shown in FIG. 1. The shoulder-belt anchor 28 defines the upper end of the shoulder belt. In the example, shown in the Figures, the webbing is slidable through the shoulder-belt anchor 28. In other examples, the upper end of the shoulder belt may be fixed to the shoulder-belt anchor 28.

The shoulder-belt anchor 28 may be vertically adjustable along the body, e.g., the pillar, to vertically adjust the upper end of the shoulder belt of the webbing. The vertical adjustment of the shoulder-belt anchor 28 is identified with “F” in FIG. 1. In other words, the shoulder-belt anchor 28 may be adjusted to a selected vertical position and locked relative to the body in that selected vertical position. “Vertical adjustment” is movement of the shoulder-belt anchor 28 upwardly and downwardly with a vertical component of movement to adjust the height of the upper end of the shoulder belt relative to the occupant. The movement of the shoulder-belt anchor 28 may be both manually controlled by the occupant and automatically controlled by the computer 12, as described further below.

The shoulder-belt anchor 28 may include a motor 30 and a guide, and in some examples includes a motor and a guide of known types. The guide supports the upper end of the shoulder belt and the motor 30 moves the guide up and down relative to the body to adjust the position of the shoulder belt on the occupant. The guide may be a D-ring, including those that are currently known as guides for shoulder belts. The motor 30 of the shoulder-belt anchor 28 may be of any suitable type, e.g., a DC motor. The motor 30 is in communication with the computer 12 so that the computer 12 can control the operation of the motor 30.

The adjustable shoulder-belt anchor 28, e.g., at least the motor 30, includes a linear actuator that moves the guide relative to the vehicle body. As one example, the guide may be in a track on the body that allows for vertical movement of the guide relative to the body, and the motor may include a drive screw that is threadedly engaged in a threaded hole of the guide to move the guide along the track.

The vehicle 10 includes a steering assembly 36 including a steering column 32 and a steering wheel 34 supported by the steering column 32. The steering wheel 34 is in the occupant cabin 14 and the steering column 32 is at least partly in the occupant cabin 14. The steering wheel 34 receives rotational input from a driver, and the steering column 32 transmits the rotation through other components of the steering system to the wheels of the vehicle 10. The vehicle 10 may include a driver airbag supported by the steering wheel 34. The steering column 32 may be adjustable. For example, the tilt of the steering column 32 (identified with “G” in FIG. 1) and the for-aft location of the steering wheel 34 (identified with “H” in FIG. 1) may be adjusted. The adjustment may be manual, e.g., with the use of a lever, and/or may be automated, e.g., with the use of motors 38. In examples in which the adjustment is automated, the motors are in communication with the computer 12 so that the computer 12 can control the operation of the motors 38.

The vehicle 10 includes a user-input device 40 to interface with the computer 12 to initiate the automated position adjustment of the interior components. The occupant may provide input to the user-input device 40 to continue automated position adjustment of the interior components after initiation. As an example, the user may implement the automated position adjustment of the interior components based on a touch-and-hold of the user-input device 40, i.e., an initial touch to initiate the automated position adjustment and maintaining the touch to continue the automated adjustment to completion. In such an example, if touch of the user-input device 40 is interrupted, automated position adjustment is terminated or suspended until touch resumes. As another example, the user may implement the automated position adjustment of the interior components based on repeated touch of the user-input device 40. In such examples, the automated position adjustment is incrementally completed from initiation to completion. An increment of the automated position adjustment is initiated in response to touch of the user-input device 40, and after that increment is completed, another touch of the user-input device 40 initiates another increment of the automated position adjustment. The user-input device 40 may be an electro-mechanical toggle, button, switch, etc. As another example, the user-input device 40 may include a display that allows for user interaction. For example, the display may be a conventional touchscreen display, such that a user may provide input to the computer 12 via a display screen. For example, the touchscreen may be any suitable type for receiving an input from a user (e.g., resistive, capacitive, infrared, etc.). As another example, the user-input device 40 may be the screen of a remote device (e.g., smartphone, smart fob, a tablet, etc.) that allows automated personalization of vehicle components.

The vehicle 10 includes an object-detection system 42. The object-detection system 42 detects measurement of the mass distribution of the occupant and is in communication with the computer 12 to communicate detection of mass distribution of the occupant to the computer 12. The object-detection system 42 identifies the presence of objects outside the vehicle 10 and/or in the occupant cabin 14. As an example, the object-detection system 42 may identify an occupant outside of the vehicle 10 prior to and/or during entry of the occupant into the occupant cabin 14. As another example, the object-detection system 42 may identify an occupant in the occupant cabin 14. The object-detection system 42 may identify the location of at least some parts of the occupant. For example, the object-detection system 42 may identify the location of a shoulder of the occupant, a torso of the occupant, a head of the occupant, etc. In such examples, the object-detection system 42 and/or the computer 12 may distinguish between parts of the occupant to identify the mass distribution of the occupant.

The object-detection system 42 may include one or more image detectors for detecting objects outside of the vehicle 10 and/or in the occupant cabin 14. The sensors provide data about objects, including measurements used for mass distribution of the occupant, to the computer 12. The sensors may have a field of view outside of the vehicle 10 for detecting the occupant outside of the vehicle 10, e.g., during entry, and/or the sensors may have a field of view in the occupant cabin 14 for detecting the occupant in the occupant cabin 14. In examples in which the sensors have a field of view outside the occupant cabin 14, the sensors may detect the mass distribution of the entire body of the occupant while the occupant is standing upright. In the example in which sensors of the object-detection system 42 have a field of view in the occupant cabin 14, the field of view may encompass one or more of the seats 16 and/or one or more occupant-seating areas 22 to view an occupant when in the occupant-seating area 22. In examples including an illumination source, the illumination source is arranged to produce illumination detectable by the sensor, and likewise the sensors are arranged to detect illumination from the illumination sources. The sensors thereby receive illumination from the illumination sources that have reflected off of the occupant.

The sensors of the object-detection system 42 can be cameras 44. The cameras 44 detect electromagnetic radiation in some range of wavelengths. For example, the cameras 44 may detect visible light, infrared radiation, ultraviolet light, or some range of wavelengths including visible, infrared, and/or ultraviolet light. For example, the cameras 44 can include image sensors such as charge-coupled devices (CCD), active-pixel sensors such as complementary metal-oxide semiconductor (CMOS) sensors, etc. The cameras 44 are configured to detect illumination ambient sources and/or from an illumination source that illuminates objects in the occupant cabin 14. In some examples, an illumination source can produce illumination in the occupant cabin 14 in some range of wavelengths, specifically, illumination detectable by the cameras 44. For example, the illumination sources may produce visible light, infrared radiation, ultraviolet light, or some range of wavelengths including visible, infrared, and/or ultraviolet light. The illumination sources are configured to produce illumination in a range of wavelengths completely or significantly encompassed by the range of wavelengths detectable by the cameras 44. For example, the illumination sources can produce and the cameras 44 can detect illumination outside a visible range, e.g., infrared illumination, e.g., near-infrared illumination (700–1300 nanometers (nm)). The illumination sources can be any suitable type for producing the desired wavelengths, e.g., for visible light, tungsten, halogen, high-intensity discharge (HID) such as xenon, light-emitting diodes (LED), etc.; for infrared light, LEDs, lasers, filtered incandescent, etc.

The vehicle 10 may include an occupant-classification sensor 48. Specifically, the vehicle 10 may include an occupant-classification system (OCS) 46, and the OCS 46 may include an occupant-classification sensor. The OCS 46 may be of a conventional type currently known in the art The occupant-classification sensor 48 detects the presence of an occupant in a seat 16 and may detect at least one size measurement of the occupant, e.g., weight, width, height, etc. As an example, the OCS 46 may use mmWave Radar, ultra-wideband (UWB) Radar, and/or LiDAR to detect the presence of an occupant in the seat 16 and to detect at least one size measurement of the occupant. In such examples, the occupant-classification sensor 48 may be or include a Radar sensor and/or a LiDAR sensor. As another example, the occupant-classification sensor 48 may be a weight sensor in the seat 16 for detecting the weight of the occupant. In such an example, the weight sensor may include a sealed bladder and a pressure sensor in communication with the sealed bladder for detecting pressure changes in the bladder when an occupant sits on the seat 16. As another example, the occupant-classification sensor 48 may be a camera 44 in the occupant cabin 14 for detecting the size and/or shape of the occupant. In such an example, the camera 44 can detect electromagnetic radiation in some range of wavelengths. For example, the camera 44 may detect visible light, infrared radiation, ultraviolet light, or some range of wavelengths including visible, infrared, and/or ultraviolet light. For example, the camera 44 can be a charge-coupled device (CCD), complementary metal oxide semiconductor (CMOS), or any other suitable type. The camera 44 may be positioned such that a field of view of the camera 44 encompasses the seat 16. Based on the detection by the occupant-classification sensor 48, the OCS 46 determines the presence of the occupant in the seat 16 and may determine the size of an occupant seated in the seat 16. In some examples, the camera 44 of the OCS may also be the camera 44 of the object-detection system 42, i.e., the camera 44 may be used by the computer 12 to identify the presence of the occupant and to measure the mass distribution of the occupant.

The vehicle 10 may include a sound-detection system 50 that detects sound in the occupant cabin 14. The sound-detection system 50 may include microphones 52designed to detect sounds generated by the occupants. The sound-detection system 50, e.g., the microphones 52, are in communication with the computer 12 and may communicate detection of audible occupant discomfort to the computer 12.

The computer 12 may be, for example, a restraints control module. The computer 12 includes a processor and a memory. The memory includes one or more forms of computer readable media, and stores instructions executable by the processor for performing various operations, including as disclosed herein. For example, the computer 12 can be a generic computer with a processor and memory as described above and/or may include an electronic control unit ECU or controller for a specific function or set of functions, and/or a dedicated electronic circuit including an ASIC that is manufactured for a particular operation, e.g., an ASIC for processing sensor data and/or communicating the sensor data. In another example, the computer 12 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in a computer. The memory can be of any type, e.g., hard disk drives, solid state drives, servers, or any volatile or non-volatile media. The memory can store the collected data sent from the sensors. The memory can be a separate device from the rest of the computer 12, and the computer 12 can retrieve information stored by the memory via a network in the vehicle 10, e.g., over a CAN bus, a wireless network, etc. Use of “in response to” and “based on” herein, including with reference to the computer 12 and methods performed by the computer 12, indicates a causal relationship, not merely a temporal relationship.

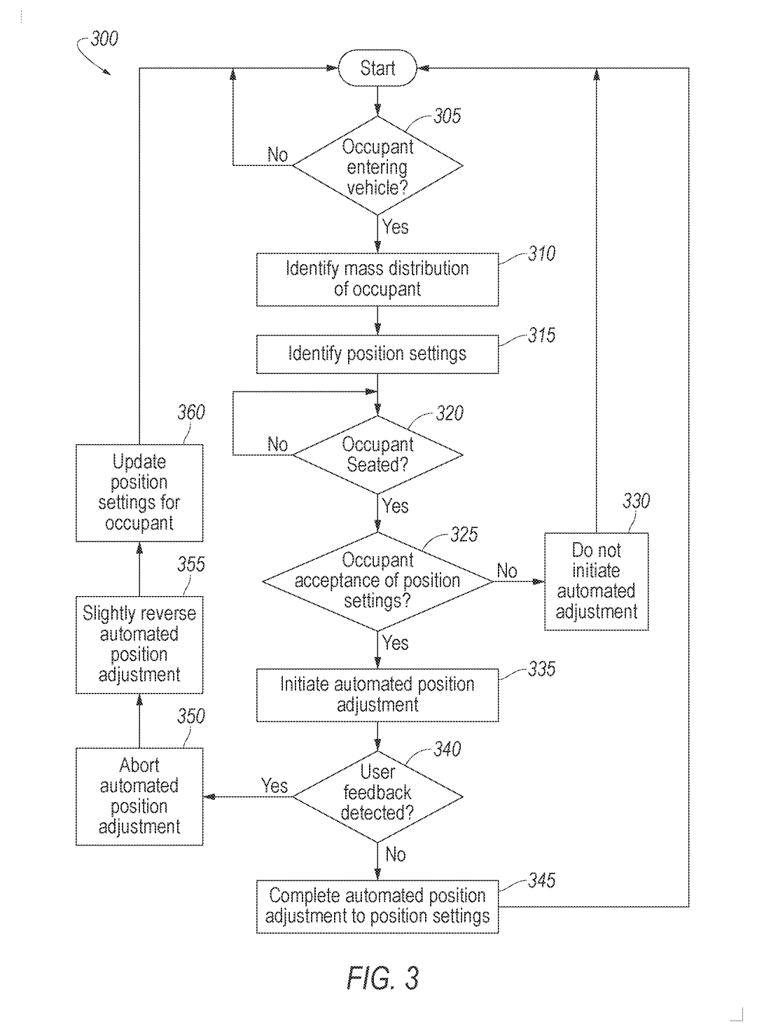

The memory of the computer 12 stores instructions executable by the processor to perform the method 300 shown in FIG. 3. In other words, the computer 12 is programmed to perform the method 300 in FIG. 3. The memory can be of any type (e.g., hard disk drives, solid state drives, servers, or any volatile or non-volatile media). The memory can store the collected data sent from the sensors. The memory can be a separate device from the computer 12, and the computer 12 can retrieve data stored by the memory via the network in the vehicle 10 (e.g., over a CAN bus, a wireless network, etc.) Alternatively, or additionally, the memory can be part of the computer 12 (e.g., as a memory of the computer 12).

The vehicle 10 includes a communication network 54 that can include a bus in the vehicle 10 such as a controller area network (CAN) or the like, and/or other wired and/or wireless mechanisms. Via the communication network 54, the computer 12 may transmit messages to various devices in the vehicle 10 and/or receive messages (e.g., CAN messages) from the various devices, e.g., sensors, an actuator, a human machine interface (HMI), etc. Alternatively, or additionally, in cases where the computer 12 includes a plurality of devices, the communication network 54 may be used for communications between devices represented as the computer 12 in this disclosure. Further, as mentioned below, various controllers and/or sensors may provide data to the computer 12 via the communication network 54.

Interior components that are actuatable by the computer 12 in response to image data from the interior object-detection system 42 include seats 16, shoulder-belt anchors 28, steering assemblies 36, etc. Specifically, the motor of the adjustable shoulder-belt anchor 28 is actuatable by the computer 12 in response to data from the object-detection system 42, e.g., from image data from cameras 44. The image data can be of objects that are in the field of view of one of the cameras 44. The objects can be classified into types. For example, one such type of object is a shoulder of the occupant, a head of the occupant, a torso of the occupant, a shoulder belt, the upper end of the shoulder belt, an adjustable shoulder-belt anchor 28, a feature of the vehicle body, a feature of the seat 16, a feature of the occupant cabin 14, etc.

The computer 12 is programmed to determine mass distribution of an occupant based on image data from the object-detection system 42. The computer 12 may also be programmed to identify an occupant and/or detect occupant discomfort based on image data from the object-detection system 42, e.g., with the use of facial recognition techniques, including, in some examples, known techniques. Specifically, for both mass distribution and facial recognition, the computer 12 may be programmed to detect whether an object of a preset type is in the image data. For example, the computer 12 can detect the type of object using conventional image-recognition techniques, e.g., a convolutional neural network programmed to accept images as input and output an identified type. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential type, and the final output is the type with the highest score. If the highest score belongs to the preset type, then the computer 12 has detected the object of the preset type.

For another example, the computer 12 can detect an object in the image data by using any suitable object-detection technique, e.g., knowledge-based techniques such as a multiresolution rule-based method; feature-invariant techniques such as grouping of edges (e.g., edge detection), space gray-level dependence matrix, or mixture of Gaussian; template-matching techniques such as shape template or active shape model; or appearance-based techniques such as Gaussian distribution and multilayer perceptron, neural network, support vector machine with polynomial kernel, a naive Bayes classifier with joint statistics of local appearance and position, higher order statistics with hidden Markov model, or Kullback relative information.

As set forth above, the computer 12 is programmed to identify the mass distribution of the occupant. The mass distribution of the occupant is the arrangement of concentration of mass of the occupant, i.e., where mass is concentrated and not concentrated relative to other parts of the body of the occupant. The mass distribution may be based on the height of the occupant (i.e., from head to feet), and the mass distribution may be based on the width (i.e., from left to right) and/or depth (i.e., from front to back) of the body of the occupant at any height. The mass distribution may be based on the height of features of the body of the occupant and/or the width and/or depth of the body of the occupant at those features. For example, such features may include anatomical features such as the neck, shoulders, torso, hips, elbows, knees.

As set forth above, the mass distribution of the occupant used to generate position settings for the interior components can be identified at the time of entry. The computer 12 may be programmed to identify mass distribution of the occupant in response to detection of entry of the occupant into the vehicle 10. Accordingly, the mass distribution of the occupant is determined prior to operation of the vehicle 10 and the interior components may be operated prior to operation of the vehicle 10. The initial presence of the occupant and/or an activity of the occupant may initiate the identification of mass distribution of the occupant. For example, mass distribution of the occupant may be identified in response to opening of a door of the vehicle 10 from the exterior of the vehicle 10, e.g., operation of a door handle or an electronic entry feature on the exterior of the vehicle 10. Operation of the door handle may be detected by a vehicle 10 sensor on the door or remote from the door. As another example, mass distribution of the occupant may be identified in response to detection of new occupancy of a seat 16. The occupancy of the seat 16 may be detected by, for example, the OCS, as described above. As another example, mass distribution of the occupant may be identified in response to detected buckling of the seatbelt assembly 26, e.g., detection of engagement of the clip of the seatbelt assembly 26 with the buckle of the seatbelt assembly 26.

The mass distribution of the occupant may be determined at the exterior of the vehicle 10 and/or in the occupant cabin 14 of the vehicle 10. In either example, the mass distribution of the occupant may be determined by measurement at the exterior of the vehicle 10 and/or in the occupant cabin 14 of the vehicle 10, and/or the mass distribution of the occupant may be accessed from previously saved mass distribution data for that occupant.

For measurements of the mass distribution of the occupant at the exterior vehicle 10 and/or in the occupant cabin 14, the measurement of mass distribution of the occupant may be based on object detection at the exterior of the vehicle 10 or in the occupant cabin 14 of the vehicle 10. For example, the body of the occupant may be measured by the sensors of the object-detection system 42, e.g., cameras 44, as described above. The computer 12 may use object detection techniques described above to determine the mass distribution of the occupant based on the measurements from the sensor of the object-detection system 42.

The computer 12 is programmed to retrieve stored data indicating mass distribution of the occupant based on occupant identification. Previously saved mass distribution data for an occupant may be saved to a user-specific account and accessed by the computer 12 in response to identification of the occupant, i.e., the determination of the unique identity of the occupant. As an example, the user-specific account may be Ford Pass® or any suitable applications. In some examples, the stored data indicating mass distribution of the occupant is stored remotely from the vehicle 10 and accessed by the computer 12 of the vehicle 10. In such examples, the computer 12 may use the previously saved mass distribution data for the occupant to identify position settings of the interior components of the vehicle 10. Thus, the previously saved mass distribution data can be used by the occupant in several vehicles to identify position settings of the interior components of various vehicles. The position settings may be different for various vehicles based on the content of the interior components of the vehicle 10.

As one example, the previously saved mass distribution data for an occupant may be based on previous measurements of mass distribution of the occupant by an object-detection system 42 of a vehicle 10. As another example, the previously saved mass distribution data for an occupant may be based on measurements taken by hardware other than a vehicle 10, e.g., by a mobile phone with the use of a camera 44 and software application of the mobile phone, personal training equipment, etc. In examples in which the previously saved mass distribution data for an occupant is from a source other than the vehicle 10 at the time of entry of the occupant, inquiries may be made to identify changes to mass distribution. As an example, the user-input device 40 may request that the occupant answer questions about changes in mass distribution, e.g., weight gain or loss, pregnancy, presence of medical braces, casts, etc. In the event the occupant indicates that mass distribution has changed, the computer 12 may update the mass distribution data for that occupant based on occupant answers to the queries.

As set forth above, in order to access mass distribution data for an occupant, the occupant is first identified and the identity is used to access the mass distribution data for that occupant. As one example, the computer 12 may identify the occupant based on facial recognition, as described above. In other examples, the computer 12 may identify the occupant based on personal electronic identification, e.g., recognition of a unique identifier such as a mobile phone that communicates with the computer 12, recognition of a key fob used by the occupant, etc.

Upon identifying the mass distribution of the occupant, the computer 12 is programmed to identify position settings for interior components of the vehicle 10 based on the mass distribution of the occupant. The position settings for one or more of the interior components may be determined from a lookup table correlating position settings of interior components to mass distribution measurements, algorithms that correlate position settings of interior components to mass distribution measurements, etc. The lookup table and/or algorithm may be empirically determined.

The interior components that are positioned according to the position settings by automated position adjustment may be, for example, a seat 16, steering wheel 34, a steering column 32, a seatbelt shoulder-anchor, etc. Specifically, as set forth above, the seat 16 may be adjusted for tilt of the seat 16, a height of the seat 16, a recline angle of the seat 16, a lumbar support position of the seat 16. The tilt of the steering column 32 and the for-aft location of the steering wheel 34 may be adjusted. The vertical height of the seatbelt shoulder-anchor may be adjusted. The computer 12 may be programmed to confirm that the occupant is seated based on data from the object-detection system 42, the OCS, etc., prior to automatic adjustment of the interior components toward the position settings. The computer 12 may be programmed to confirm that the vehicle 10 is in Park prior to automatic adjustment of the interior components toward the positions settings.

The computer 12 initiates automated position adjustment of the interior components toward the position settings after identification of the position settings based on the mass distribution of the occupant. Specifically, the initiation of automated position adjustment may be in response to input from the occupant to the user-input device 40. As set forth above, the automated position adjustment may, in some examples, be performed by a touch-and-hold function or a repeated touch function. The adjustment of the interior components is automated by the motors 30, 38, actuators 24, etc., as controlled by the computer 12 as described herein.

In the absence of detection of occupant discomfort, the computer 12 is programmed to move the interior components to the position settings that were determined based on mass distribution of the occupant. The computer 12 is programmed to abort automated position adjustment in response to detection of occupant discomfort. Occupant discomfort includes unwanted positioned of interior components that may be uncomfortable to the occupant and/or a nuisance to the occupant. Occupant discomfort is identified by audible and/or visual cues. The audible cues may be detected by the sound-detection system 50, as set forth above. Audible cues of occupant discomfort may be, for example, sighs, words such as “stop,” etc. The visual cues may be detected by the object-detection system 42, as set forth above. Visual cues of occupant discomfort may be, for example, flinching, facial frowning or grimacing, etc. Combinations of audible cues and visual cues may be indications of occupant discomfort.

In some examples, when automated position adjustment is aborted, the computer 12 may maintain the position of the interior components at the position when the automated position adjustment was aborted. In other examples, the computer 12 may instruct the occupant to manually adjust the interior components. In other examples, the computer 12 may recalculate the position settings for the interior components and apply the adjusted position settings. In some examples, the computer 12 is programmed to slightly reverse the automated position adjustment in response to detection of occupant discomfort. As an example, the computer 12 is programmed to move the interior components to the position that the interior components occupied at a time that preceded the detection of occupant discomfort. That time may be a predetermined period of time, e.g., one second. In such an example, the computer 12 returns the interior components to the position that the interior components occupied at the time that immediately preceded the detection of occupant discomfort by the period of time. The reversal of the automated position adjustment may be follow the same path or a different path in which the interior components moved in the period of time preceding the detection of occupant discomfort.

As set forth above, the position settings for the interior components are tailored to the mass distribution of the occupant and can be saved for later use for that occupant. The computer 12 may be programmed to update position settings for interior components based on occupant feedback. The updated positions settings are unique to the occupant, and the updated positions settings may be specific to a vehicle and/or a vehicle model. In other words, the computer 12 may store different position settings for different vehicles and/or different vehicle 10 models for the same occupant. In the event the position settings are updated, the updated position settings are accessed for future use when the occupant is identified, e.g., by facial recognition, personal electronic recognition, etc., as described above.

As one example, the computer 12 is programmed to update position settings for interior components based on detection of occupant discomfort. In the event that the automated position adjustment is aborted, the computer 12 may update the position settings for the interior components for that occupant so that when the position settings for that occupant are accessed in future uses, the automated position adjustment does not cause the user discomfort previously experienced during previous automated position adjustments. As another example, the computer 12 is programmed to update position settings for interior components based on user termination of the automated position adjustment, e.g. by terminating touch of the user-input device 40 during a touch-and-hold function or by not touching the user-input device 40 during a repeated touch function.

With reference to FIG. 3, the computer 12 is programmed to perform the example method 300. The method 300 is initiated by detection of an occupant entering the vehicle 10, as shown in block 305. As set forth above, entry of the occupant to the vehicle 10 may be detected by approach detection of their smart key or fob, operation of a door handle or an electronic entry feature on the exterior of the vehicle 10. detection of new occupancy of the seat 16, buckling of the seatbelt assembly 26, etc.

In response to detecting entry of an occupant to the vehicle 10, the method 300 includes identifying the mass distribution of the occupant, as shown in block 310. The mass distribution may be identified with the use of the object-detection system 42 and/or based on previously saved mass distribution data, as described above. The mass distribution data of the occupant may also be obtained and/or supplemented with queries of the occupant, e.g., through the user-input device 40, as described above.

With reference to block 315, the method 300 includes identifying position settings for the interior components based on the mass distribution of the occupant. As set forth above, examples of interior components for which position settings are identified include a seat 16, steering wheel 34, a steering column 32, a seatbelt shoulder-anchor, etc. The position settings include tilt of the seat 16, a height of the seat 16, a recline angle of the seat 16, a lumbar support position of the seat 16, tilt of the steering column 32, the for-aft location of the steering wheel 34, vertical height of the seatbelt shoulder-anchor, etc.

In decision block 320, the method 300 includes confirming that the occupant is seated in the seat 16 before automated position adjustment. The computer 12 may confirm that the occupant is seated based on data from the object-detection system 42, the OCS, etc. The method 300 may include receiving confirmation that the vehicle 10 is in Park prior to automatic adjustment of the interior components toward the position settings.

The method 300 includes receiving input from the occupant confirming acceptance of the determination of position settings and the initiation of the automated position adjustment, as shown in block 325. As an example, the computer 12 may prompt the occupant to accept initiation of the automated position adjustment through the user-input device 40. The occupant may initiate the automated position adjustment by a touch-and-hold function or a repeated touch function, as described above. In the event the occupant does not accept the initiation of the automated position adjustment, the method 300 does not adjust the interior components by automated position adjustment, and instead the method 300 returns to start. The occupant may manually adjust the interior components.

In response to input from the occupant approving initiation of the automated position adjustment in block 325, the method 300 includes initiating automated position adjustment, as shown in block 335. Specifically, the computer 12 controls the motors 30, 38 and/or actuators 24 of the interior components (e.g., seats 16, steering column 32, seatbelt shoulder anchor, etc.), to move the interior components toward the position settings determined for the mass distribution of the occupant. The method 300 continues to move the interior components to the position settings absent user feedback to the contrary, as shown in block 345. After adjustment of the interior components to the position settings, the occupant may thereafter manually adjust the interior components.

The method 300 includes determining whether user feedback terminating the automated position adjustment is detected, as shown in block 340. User feedback may be, for example, a detection of occupant discomfort. Occupant discomfort may be detected by the object-detection system 42 and/or the sound-detection system 50, as described above. As another example, user feedback may be user termination of the automated position adjustment, e.g. by terminating touch of the user-input device 40 during a touch-and-hold function or by not touching the user-input device 40 during a repeated touch function.

In the event user feedback to terminate the automated position adjustment is detected, the method 300 includes aborting the automated position adjustment, as shown in block 350. Specifically, the positions of the interior components, respectively, may be maintained after detection of user feedback to terminate the automated position adjustment. After the automated position adjustment is aborted, the occupant may thereafter manually adjust the interior components.

In the event the automatic position adjustment is aborted, the method 300 includes slightly reversing the automated position adjustment, as shown in block 355. As set forth above, the automated position adjustment may be reversed for a period of time after the automated position is aborted. In some examples, the method 300 includes returning the interior components to the position that the interior components occupied at the time that immediately preceded the detection of occupant discomfort by the period of time. As set forth above, the reversal of the automated position adjustment may be follow the same path or a different path in which the interior components moved in the period of time preceding the detection of occupant discomfort.

With reference to block 360, the method 300 includes updating position settings for the occupant base on the termination of the automated position adjustment. As set forth above, the position settings may be stored remote from the vehicle 10. The updated positions settings are unique to the occupant, and the updated positions settings may be specific to a vehicle and/or a vehicle model. In other words, the computer 12 may store different position settings for different vehicles and/or different vehicle models for the same occupant. In the event the position settings are updated, the updated position settings are accessed for future use when the occupant is identified, e.g., by facial recognition, personal electronic recognition, etc., as described above.

In general, the computer 12 may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

The computer 12 generally includes computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer readable medium (also referred to as a processor readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer including a processor and memory storing instructions by the processor to:
identify a mass distribution of an occupant;
identify position settings for interior components of a vehicle based on the mass distribution of the occupant;
initiate automated position adjustment of the interior components toward the position settings; and
abort automated position adjustment in response to detection of occupant discomfort, the occupant discomfort being audible and/or visual.

2. The computer as set forth in claim 1, wherein the instructions to identify the mass distribution of the occupant include instructions to retrieve stored data indicating mass distribution of the occupant based on occupant identification.

3. The computer as set forth in claim 2, wherein the instructions include instructions to update the stored data based on detection of occupant discomfort.

4. The computer as set forth in claim 2, wherein the instructions include instructions to identify the occupant based on facial recognition.

5. The computer as set forth in claim 2, wherein the instructions include instructions to identify the occupant based on personal electronic identification.

6. The computer as set forth in claim 1, wherein the detection of occupant discomfort includes detection of facial expression of discomfort.

7. The computer as set forth in claim 1, wherein the instructions include instructions to update stored data based on an occupant answer to a query.

8. The computer as set forth in claim 7, wherein the instructions include instructions to initiate the query in response to detection of a change in mass distribution of the occupant relative to the stored data.

9. The computer as set forth in claim 1, wherein the instructions include instructions to identify the mass distribution of the occupant in response to detection of entry of the occupant into the vehicle.

10. The computer as set forth in claim 1, wherein the automated position adjustment of interior components includes position adjustment of a seat.

11. The computer as set forth in claim 1, wherein the instructions include instructions to reverse the automated position adjustment for a period of time after the automated position is aborted.

12. A method comprising:
identifying a mass distribution of an occupant;
identifying position settings for interior components of a vehicle based on the mass distribution of the occupant;
initiating automated position adjustment of the interior components toward the position settings; and
aborting automated position adjustment in response to detection of occupant discomfort, the occupant discomfort being audible and/or visual.

13. The method as set forth in claim 12, wherein identifying the mass distribution of the occupant includes retrieving stored data indicating mass distribution of the occupant based on occupant identification.

14. The method as set forth in claim 13, further comprising updating the stored data based on detection of occupant discomfort.

15. The method as set forth in claim 13, further comprising identifying the occupant based on facial recognition.

16. The method as set forth in claim 13, further comprising identifying the occupant based on personal electronic identification.

17. The method as set forth in claim 12, wherein the detection of occupant discomfort includes detecting facial expression of discomfort.

18. The method as set forth in claim 12, further comprising updating stored data based on an occupant answer to a query.

19. The method as set forth in claim 12, further comprising identifying the mass distribution of the occupant in response to detection of entry of the occupant into the vehicle.

20. The method as set forth in claim 12, further comprising reversing the automated position adjustment for a period of time after the automated position is aborted.
